(19) United States
(12) Patent Application Publication
(10) Pub. No.: US 2017/0296306 A1
(43) Pub. Date: Oct. 19, 2017

(54) ORTHODONTIC APPLIANCE AND METHOD FOR CLASS II AND CLASS III MALOCCLUSION AND DENTAL ASYMMETRIC CORRECTION

(71) Applicant: RMO, Inc., Denver, CO (US)

(72) Inventor: Bradford N. Edgren, Greeley, CO (US)

(21) Appl. No.: 15/380,814

(22) Filed: Dec. 15, 2016

Related U.S. Application Data
(63) Continuation-in-part of application No. 13/919,545, filed on Jun. 17, 2013, now abandoned.
Application No. 13/919,545 is a continuation-in-part of application No. 13/240,850, filed on Sep. 22, 2011, now abandoned.
(60) Provisional application No. 61/385,212, filed on Sep. 22, 2010.

(51) Int. Cl. A61C 7/36; A61C 7/22

(52) U.S. Cl. CPC A61C 7/36; A61C 7/22

(57) ABSTRACT

An orthodontic correction system is disclosed for correcting Class II malocclusions, Class III malocclusions, dental asymmetries and/or dental related skeletal anomalies in which the patient's dentition is permanent or near permanent. The correction system attaches to a patient's dentition via a novel orthodontic appliance that is affixed to, e.g., pre-installed upper and lower archwires. The correction system includes one or more adjustable length assemblies each of whose ends pivotally attach to a patient's preinstalled maxillary and mandibular archwires. Each pivot is a ball hinge comprising a spherical head that pivotally attaches, allowing the alignment assembly to have free excursion, motion, and/or rotation along multiple axes.

### CROSS REFERENCE TO RELATED APPLICATIONS

The present application is a continuation in part of U.S. patent application Ser. No. 13/919,545, filed 17 Jun. 2013, which is a continuation in part of U.S. patent application Ser. No. 13/240,850, filed 22 Sep. 2011, which claims the benefit of U.S. Provisional Patent Application 61/385,212, filed 22 Sep. 2010. The disclosures of each of these previous applications is incorporated herein by reference.

### FIELD OF THE INVENTION

The present disclosure is directed to an orthodontic system and method for correcting Class II and Class III malocclusions as well as dental asymmetries, wherein a variable length assembly is provided for attaching to both maxillary and mandibular pre-installed archwires. The orthodontic systems and methods of the present invention utilize a ball hinge at each of the two ends of the alignment assembly, allowing freedom of rotation of the alignment assembly along multiple axes.

### BACKGROUND

Prior Art orthodontic correction devices/systems for Class II malocclusions, Class III malocclusions, and/or dental asymmetries can be useful for mixed dentitions (e.g., a mixture of permanent and deciduous dentition). However at least some such correction devices/systems are patient removable orthodontic appliances.

It would be advantageous to have an orthodontic correction system that can be effective for correcting Class II malocclusions, Class III malocclusions, dental asymmetries and/or dental related skeletal anomalies wherein the patient's dentition is permanent or near permanent. In particular, it would be advantageous to have such an orthodontic correction system that can be fitted to a patient's currently fitted orthodontic appliances (e.g., brackets and archwires) which are non-removable by the patient. Moreover, it is desirable to utilize such an orthodontic correction system without having to perform an extraction of a patient's dentition. The advantages recited hereinabove are meet by the orthodontic correction system disclosed hereinbelow.

### SUMMARY

An orthodontic correction system is disclosed for correcting Class II malocclusions, Class III malocclusions, dental asymmetries and/or dental related skeletal anomalies wherein the patient's dentition is permanent or near permanent. The correction system attaches to a patient's dentition via a novel orthodontic appliance that is affixed to, e.g., pre-installed upper and lower archwires. The correction system utilizes a ball hinge at each of the two ends of the alignment assembly, allowing freedom of rotation of the alignment assembly along multiple axes.

Accordingly, the orthodontic correction system disclosed herein is particularly useful for those patients that already have fixed appliances installed, and are currently undergoing orthodontic care. However, the present orthodontic correction system may also be provided as part of a planned orthodontic treatment prior to the start of such treatment to help correct the malocclusions and/or create space for impacted teeth. Moreover, the present orthodontic correction system may be particularly useful for patients that are uncooperative or unreliable in utilizing other orthodontic appliances (e.g., patient removable appliances) for correcting Class II, Class III, dental asymmetries and/or dental related skeletal anomalies.

In some installations and orthodontic treatments of Class III malocclusions with the correction system disclosed herein, maxillary teeth can be moved mesially, while mandibular teeth are moved distally so that a Class I classification of a patient's dentition results as one skilled in the art will understand.

Further description of the advantages, benefits and patentable aspects of the present disclosure will become evident from the description hereinbelow and the accompanying drawings. All novel aspects of the disclosure, whether mentioned explicitly in this Summary section or otherwise (e.g., hereinbelow), are considered subject matter for patent protection either singly or in combination with other aspects of this disclosure. Accordingly, such novel aspects disclosed hereinbelow and/or in the drawings that may be omitted from, or less than fully described in, this Summary section are fully incorporated herein by reference into this Summary. In particular, all claims of the Claims section hereinbelow are fully incorporated herein by reference into this Summary section.

### BRIEF DESCRIPTION OF THE DRAWINGS

FIG. 1 shows a cross sectional view of the archwire attachment 30 (for better clarity, the cross section is not cross hatched).

FIG. 2 shows a first embodiment of the alignment assembly 18 attached to archwires 26 that are secured to a patient's dentition.

FIG. 3 shows a second embodiment of the alignment assembly 18 attached to archwires 26 that are secured to a patient's dentition.

FIG. 4 shows a third embodiment of the alignment assembly 18 attached to archwires 26 that are secured to a patient's dentition.

FIG. 5 shows a cross sectional view of the archwire attachment 30 (for better clarity, the cross section is not cross hatched), how the alignment assembly 18 attaches thereto, and how the archwire attachment 30 fixedly attaches to an archwire 26.

FIG. 6 shows a cross sectional view of a second embodiment of the archwire attachment (30a) (for better clarity, the cross section is not cross hatched), how the alignment assembly 18 attaches thereto, and how the archwire attachment 30a fixedly attaches to an archwire 26.

FIG. 7 shows a cross sectional view of a third embodiment of the archwire attachment (30b) (for better clarity, the cross section is not cross hatched), how the alignment assembly 18 attaches thereto, and how the archwire attachment 30b fixedly attaches to an archwire 26.

FIG. 8 shows a cross sectional view of a fourth embodiment of the archwire attachment (30c) (for better clarity, the cross section is not cross hatched).

FIG. 9 shows a cross sectional view of a fourth embodiment of the archwire attachment (for better clarity, the cross section is not cross hatched). A solid pin with a head is used to secure the archwire.

FIG. 10 shows an alternative component for securing an archwire attachment (30d).

FIG. 11 shows a fourth embodiment of the alignment assembly 18 attached to archwires 26 that are secured to a patient's dentition for Class III correction.

FIG. 12 shows an embodiment where teeth are brought into various alignment through use of the alignment assembly 18.

FIG. 13 shows one embodiment of a screw having a ball hinge at its end to pivotally attach to the alignment assembly 18.

FIG. 14 shows one embodiment where a keyhole slot accepts a male piston assembly's spherical head.

FIG. 15A is a side view of a ball/socket screw embodiment with a clip style eyelet attachment 58a attaching the piston assembly 18 to the attachment screw.

FIG. 15B is a top view of one embodiment of a clip style eyelet attachment 58a showing arms 75 that spread apart to slip around shaft 51, and then close to securely attach the assembly to the screw.

FIGS. 16A through 16H are pre-treatment photos of a patient treated with an embodiment of the present invention as described in Clinical Example 1.

FIG. 16I is a pre-treatment x-ray of the patient of Clinical Example 1.

FIGS. 17A through 17H are post-treatment photos of the patient of Clinical Example 1.

FIG. 17I is a post-treatment x-ray of the patient of Clinical Example 1.

FIGS. 18A through 18H are pre-treatment photos of a patient treated with an embodiment of the present invention as described in Clinical Example 2.

FIGS. 19A through 19C are mid-treatment photos of the patient of Clinical Example 2.

FIGS. 20A through 20H are post-treatment photos of the patient of Clinical Example 2.

FIGS. 21A through 21H are pre-treatment photos of a patient treated with an embodiment of the present invention as described in Clinical Example 3.

FIG. 21I is a pre-treatment x-ray of the patient of Clinical Example 3.

FIGS. 22A through 22E are mid-treatment photos of the patient of Clinical Example 3.

FIGS. 23A through 23H are post-treatment photos of the patient of Clinical Example 3.

FIG. 23I is a post-treatment x-ray of the patient of Clinical Example 3.

### DETAILED DESCRIPTION

As provided hereinbelow, the term “set screw,” “set screw/shaft” are intended to be broadly interpreted as any mechanism that can secure a first component in a fixed position relative to a second component.

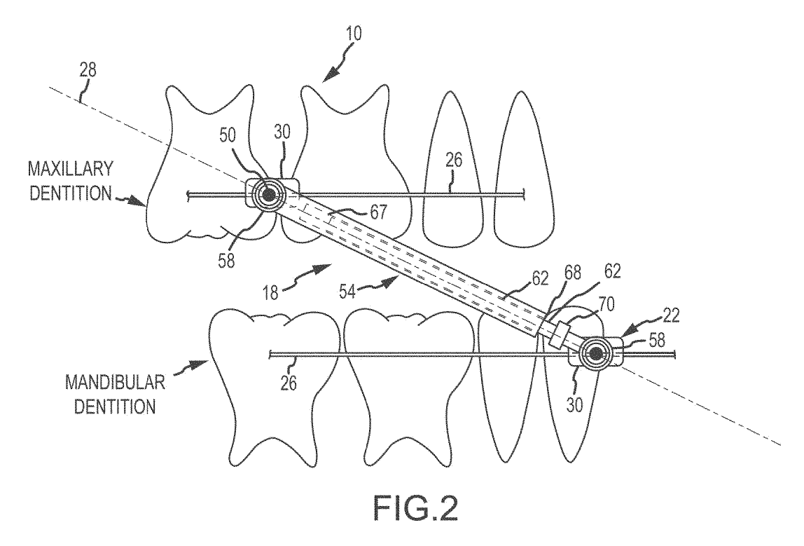

FIGS. 2-4 and 9 show various embodiments of the novel orthodontic correction system 10 of the present disclosure. In particular, the correction system 10 includes at least one correction assembly 14 having a variable length alignment assembly 18 useful in providing corrective orthodontic forces to a patient's dentition and/or jaw via hinges 22 that attach the alignment assembly between maxillary and mandibular archwires 26. In particular, the alignment assembly 18 can have its length varied along the axis 28 by an orthodontic clinician. More particularly, such an alignment assembly 18 may have one its hinges 22 connected each of the alignment assembly's ends so that, e.g., one hinge 22 connects the alignment assembly to a desired position along a maxillary positioned archwire 26, and a second hinge 22 connects the alignment assembly to a desired position along a mandibular positioned archwire 26 as shown in FIGS. 2-4 and 9. Accordingly, the combination of the hinges 22 and the attached alignment assembly 18 allow patient jaw movement (e.g., jaw and mouth opening and closing), while also providing desired orthodontic corrective forces on the patient's dentition and/or jaw.

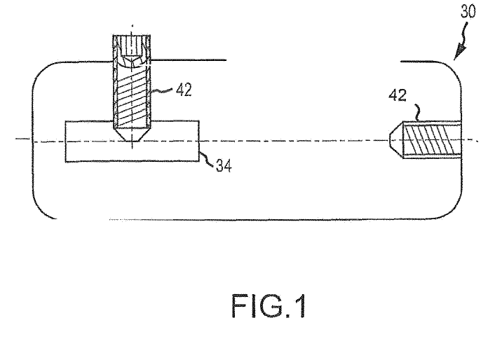

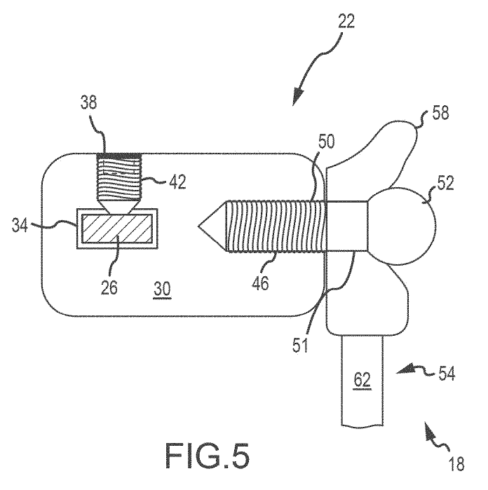

Embodiments of the hinges 22 include an archwire attachment 30 (FIGS. 1-5) that can be directly affixed to the archwires 26 in a desired position along the length of each of the archwires. In particular, referring to FIG. 5, each archwire attachment 30 includes: (a) an archwire slot 34 therethrough for providing a corresponding archwire 26 therein, (b) a set screw/shaft (hex head) 38, (c) a threaded bore 42 for mating with the set screw/shaft 38 for securing the archwire attachment 30 along the length of the corresponding archwire 26, the bore extending into the archwire slot 34 at, e.g., a 90 degree angle to the side of the slot being pierced by the bore, and (d) a threaded bore 42 for mating with, e.g., a threaded screw/shaft 50 (having a head 52) for pivotally securing the alignment assembly 18 thereto. Thus, each archwire attachment 30 provides both a connection point for connecting a dentition fixed archwire 26 to its corresponding alignment assembly 18 in a manner that allows for pivoting movement about the screw/shaft 50.

The hinges 22 may be made of an acceptable orthodontic metal alloy (e.g., stainless steel), a ceramic or a plastic as one skilled in the will understand. The archwire slot 34 (and other corresponding embodiments thereof described hereinbelow) may be effective for receiving an archwire 26 having cross sectional dimensions of, e.g., 0.022×0.025 inches, and/or 0.018×0.025 inches. The alignment assembly 18 includes a piston assembly 54 and two pivot eyelets 58. The piston assembly 54 is attached to each of the maxillary and mandibular archwires 26 via, e.g., a corresponding one of the two pivot eyelets 58 (best shown in FIG. 5) which attaches to each terminal end of the piston assembly. In particular, each eyelet 58 receives a corresponding screw/shaft 50 therethrough such that the eyelet pivotally attaches the alignment assembly 18 to a corresponding one of the archwire attachments 30. More particularly, the head 52 of such a corresponding screw/shaft 50 prevents the eyelet 58 from disengaging from the shaft of the corresponding screw/shaft 50. Note that each piston assembly 54 includes at least a male piston shaft 62 and a female piston sleeve 66, wherein the male piston shaft is capable of snugly sliding within a sleeve interior cylinder 67 accessed via an open end 68 of the piston sleeve such that a free end of the shaft 69 remains within sleeve interior cylinder during operation of the alignment assembly 18 in a patient's mouth.

Corrective orthodontic forces are induced on a patient's dentition and/or jaw by fixing the length of the piston assembly 54 in a manner that induces an orthodontic corrective force(s) between the maxillary and mandibular archwires 26. More specifically, for each installed alignment assembly 18, the length thereof (when its piston 62 is fully retracted within its sleeve 66) induces forces along the corresponding axis 28 when, e.g., the patient has his/her maxillary and mandibular dentition are “closed”, i.e., together (or as together as such maxillary and mandibular dentition can be obtained depending on the configuration and orientation of the installed one or more alignment assemblies 18). In particular, when the patient's dentition is closed, such induced forces are transferred to the attached archwires 26 and then to the patient's teeth for inducing corrective forces on the teeth and/or the patient's maxillary-mandibular relative alignment. Moreover, since the extent with which the piston 62 can slide within its sleeve 66 can varied by an orthodontic clinician, these induced forces can be varied in magnitude, and since the archwire alignments 30 can be varied along the archwires 26 (e.g., by the orthodontic clinician), the direction of such induced forces can also be varied. Accordingly, an orthodontic clinician may periodically change the length(s) of the one or more installed piston assemblies 54 as the patient's dentition and/or jaw responds to the force(s) exerted thereon by the piston assemblies 54. More particularly, the correction system 10 may include a plurality of correction assemblies 14 (e.g., one on each of the right and left sides of the patient's dentition) for exerting desired forces on each of the left and right sides of the patient's face and/or dentition.

For a Class II malocclusion, one of the correction assemblies 14 may be fixed (between maxillary and mandibular archwires 26) on each of the left and right sides of the patient's dentition so that the corresponding induced orthodontic forces, applied to each of the left and right side of the patient's jaw, are substantially the same for urging the patient's lower jaw and/or dentition to develop/move uniformly forward and thereby correct the Class II malocclusion. Alternatively, in the case of an orthodontic asymmetry, there may be one or more of the alignment assemblies 18 used for moving the patient's teeth so that, e.g., the maxillary midline and the mandibular midline are urged to coincide or align with one another. For an orthodontic asymmetry, more than one of the alignment assemblies 14 may be used, wherein their respective piston assemblies 54 may be set at different lengths to induce corrective orthodontic forces in substantially different directions. For example, since asymmetric dentition may be accompanied by a Class I malocclusion on one side of the patient's dentition, and a Class II malocclusion on the other side such that the upper and lower midlines do not coincide with each other or with the facial midline, a plurality of the correction assemblies 14 may be used wherein at least two such assemblies induce forces that purposefully differ in magnitudes, and/or their directions along their respective axes 28. In particular, for treating such an asymmetry, one or more correction assemblies 14 may be installed on each side of the patient's dentition, wherein the correction assemblies on one side of the patient's dentition are: (i) longer than those on the other side of the patient's dentition, and (ii) oriented at an angle more traverse to the axes of the patient's teeth.

Additionally, for treating a Class III malocclusion, one of the correction assemblies 14 may be fixed (between maxillary and mandibular archwires 26) on each of the left and right sides of the patient's dentition so that orthodontic forces applied to each of the left and right side of the patient's jaw are substantially the same for inducing the mandibular dentition to move uniformly backward and the upper dentition to move uniformly forward, thereby correcting the Class III malocclusion (see FIG. 9, wherein the front of the patient's dentition is on the right). In one embodiment, one or more shims 70 may be inserted onto (and surrounding) the shaft 62 (FIG. 2) in a manner that prevents the piston sleeve 66 from receiving a portion of the length of the shaft 62 adjacent the eyelet 58 to which the shaft 62 attaches, and thus by varying the thickness of the shims on the shaft 62, the shortest length of the alignment assembly 54 can be varied by an orthodontic clinician. Each of the shims 70 may be cylindrical in shape with a center opening (not shown) extending through the shim along a center axis of symmetry for insertion of a shaft 62 therethrough to attach the shim to the shaft. Thus, the thickness of the shim 70 (along the axis 28 when the shim is provided on the shaft 62 corresponding with this axis) increases the shortest length that the alignment assembly 18 having the shim attached thereto, and in particular, increases this shortest length by the thickness of the shim. In one embodiment, such shims 70 may be composed of hard rubber to act as a cushioning material that does not permanently deform under a patient's bite pressure. However, other materials can be used for the shims 70 such as a dental approved plastic or silicon with acceptable elastomeric and hardness properties so that the shims 70 cannot permanently deform or compress under typical bite pressures. For example, such acceptable elastomeric and hardness properties may include a Shore hardness in a range of 60 to 90, more preferably in a range of 70 to 80 (on the ASTM D2240 type A scale). However, other ranges are also acceptable, e.g., depending on the patient (child or adult, etc.). Note that such a cushioning material that does not permanently deform under a patient's bite pressure may be particularly advantageous in treatments for correcting Class III malocclusions.

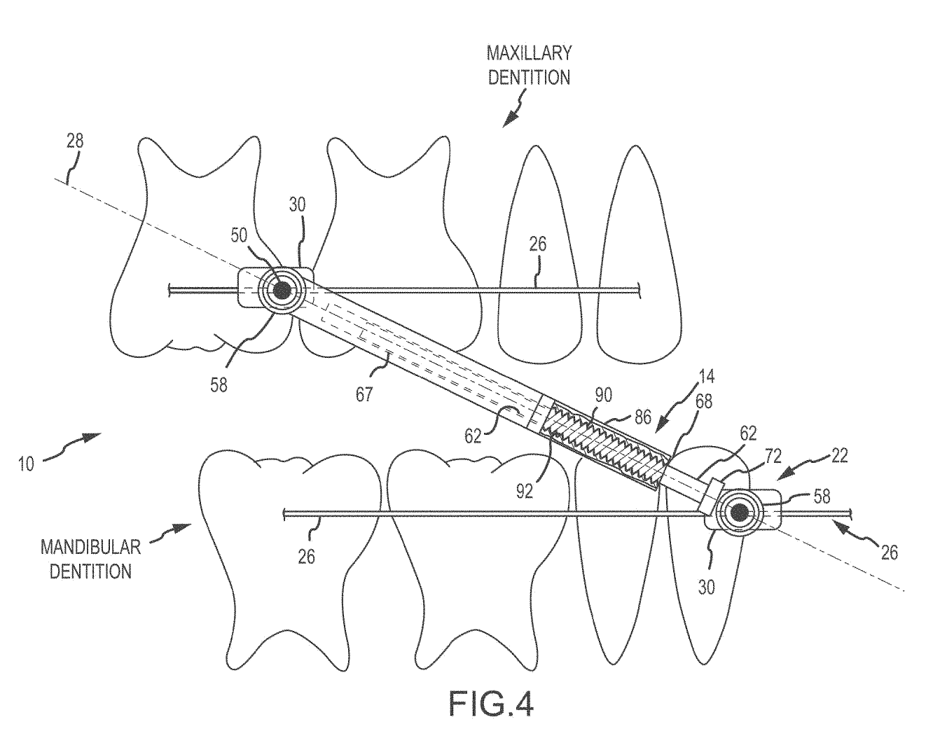

Note that since the shims 70 have an outer extent traverse to the axis 28 that cannot fit within the piston sleeve 66, and since the one or more shims fit tightly around the shaft 62 and do not readily substantially deform (even under jaw pressure), the shims are prevented from slipping over the eyelet 58 to which the shaft is attached. Accordingly, when the shim(s) 70 are provided on the shaft 62 (e.g., by an orthodontic clinician), the shim(s) remain sandwiched between the piston sleeve 66 and the eyelet 58 formed at the end of the shaft until the orthodontic clinician removes them. Further note that insertion and/or removal of the one or more shims 70 may be readily performed by the orthodontic clinician removing the alignment assembly 18 from the archwires 26 and then disassembling the piston assembly 54. More particularly, upon removal of the alignment assembly 18 from a patient's dentition, a clinician may retract the shaft 62 from the piston sleeve 66, insert the shaft through the center opening of each of the one or more shims 70 of the desired thickness (i.e., along the length of the shaft), and then reinsert the free end of the shaft back into the piston sleeve 66. Accordingly, the shortest length of the resulting alignment assembly 18 is increased by the thickness of the shim(s) inserted on the shaft 62. In some embodiments, a lip 72 (shown in the embodiment of FIG. 4) may be provided between the shaft 62 and the shaft's eyelet but the lip has an increased outer extent relative to the shaft, and wherein the lip provides, e.g., a planar surface orthogonal to the length of the shaft that the shims 70 can abut against. The lip 72 may be included in a part that is both attachable and detachable from the shaft 62 so that a shim(s) 70 may be more easily provided on the shaft. For example, the lip 72 and the adjacent eyelet 58 may be provided as a part that is separable from their shaft 62, wherein this part may be threaded over the end of the shaft that is operably immediately adjacent to the lip (i.e., not the free end 69 of the shaft). In such an embodiment, the result of connecting this part to the shaft may result in an expanded diameter or extent traverse to the axis 28. Accordingly, the sleeve interior cylinder 67 at its open end 68 may require a corresponding expanded diameter or extent so that the expanded portion of the part and the shaft 62 can fit therein.

In one embodiment, alignment assembly 18 may be provided with a single shim 70 on the shaft 62, wherein this shim has a set screw (not shown) threaded within a side of the shim so that the orthodontic clinician can fix the position of the shim along its shaft by tightening this set screw so that the shim is fixedly attached to the shaft 62 and cannot slide along a length of the shaft.

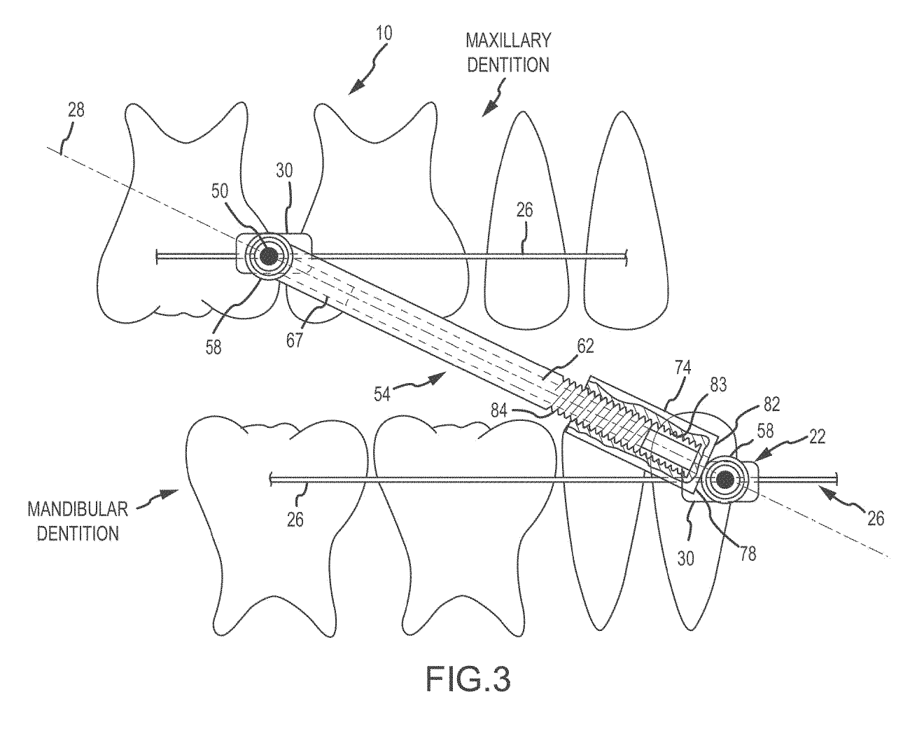

In another embodiment, the length of the piston assembly 54 (and correspondingly the length of the alignment assembly 18) may be modified by a collar 74 (FIG. 3) that surrounds both a portion of the shaft 62 and at least the open end 68 of the piston sleeve 66. The collar 74 may be substantially cylindrical wherein the end 78 thereof includes an opening 82 through which the shaft 62 extends such that the shaft and the collar can slide relative to one another through this opening. The collar 74 may be threadedly attached to the piston sleeve 66 so that by rotating the collar in one direction about the axis 28 of the piston assembly 54 length, internal threads 83 to the collar 74 mate with at least a portion of corresponding threads 84 on the external surface of the piston sleeve 66. extends the length of the piston sleeve and collar combination. Alternatively, if the collar 74 is rotated in the opposite direction about the axis 28, the collar 74 internal threads unscrew from the mating threads on the external surface of the piston sleeve 66. Accordingly, the collar 74 reduces the length of the piston sleeve 66 and collar combination. Thus, by varying the extent to which the collar 74 internal threads mate with the exterior threats of the sleeve 66, the length of the alignment assembly 18 may be varied. In particular, when the mating threads overlap more, the alignment assembly 18 shortens, and when the mating threads overlap less, the alignment assembly lengthens. Note that, as above, a lip 72 (shown in the embodiment of FIG. 4) may be provided between the shaft 62 and the shaft's eyelet such that the lip is integral with the shaft but the lip has an increased outer extent relative to the shaft, and wherein the lip provides, e.g., a planar surface orthogonal to the length of the shaft that the end 78 can abut against.

In one embodiment, instead of, or in addition to, the collar 74 being threaded for operation in varying the length of the alignment assembly 18 as described above, the collar 74 may have a set screw (not shown) threaded therein for tightly contacting the piston shaft 62 thereby securing the collar in position.

In another embodiment, the length of the piston assembly 54 (and correspondingly the length of the alignment assembly 18) may be modified by a collar 74 (FIG. 3) that surrounds both a portion of the male piston shaft 62 and at least the open end 68 of the female piston sleeve 66. The collar 74 may be substantially cylindrical wherein the end 78 thereof includes an opening 82 through which the male piston shaft 62 extends such that the shaft and the collar can slide relative to one another through this opening. The collar 74 may be threadedly attached to the female piston sleeve 66 so that by rotating the collar in one direction about the axis 28 of the piston assembly 54 length, internal threads 83 to the collar 74 mate with at least a portion of corresponding threads 84 on the external surface of the female piston sleeve 66 extends the length of the piston sleeve and collar combination. Alternatively, if the collar 74 is rotated in the opposite direction about the axis 28, the collar 74 internal threads unscrew from the mating threads on the external surface of the female piston sleeve 66. Accordingly, the collar 74 reduces the length of the piston sleeve and collar combination. Thus, by varying the extent to which the collar 74 internal threads mate with the exterior threats of the sleeve 66, the length of the alignment assembly 18 may be varied. In particular, when the mating threads overlap more, the alignment assembly 18 shortens, and when the mating threads overlap less, the alignment assembly lengthens. Note that, as above, a lip 72 (shown in the embodiment of FIG. 4) may be provided between the male piston shaft 62 and the shaft's eyelet such that the lip is integral with the shaft but the lip has an increased outer extent relative to the shaft, and wherein the lip provides, e.g., a planar surface orthogonal to the length of the shaft that the end can abut against.

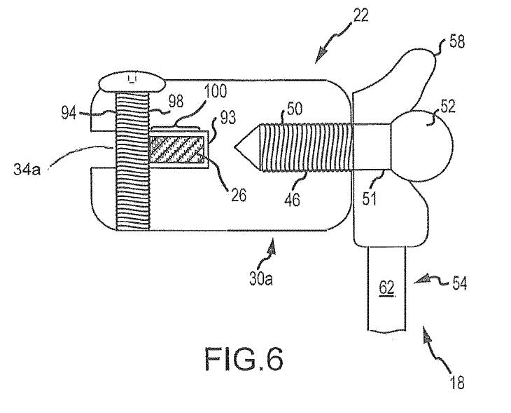

An alternative embodiment of the archwire attachment (30a) is shown in FIG. 6, wherein instead of having a fully enclosed slot (requiring the archwire 26 to be inserted therethrough), a slot 34a is provided which is open on the side of the archwire attachment 30a facing the patient's teeth. Accordingly, the archwire attachment 30a can be easily attached to an archwire 26 already in place in on a patient's dentition. In particular, once a desired position along the length of the archwire 26 is determined, the archwire 26 (e.g., at the desired position or approximately so) can be slid into the open-ended slot 34a until the archwire contacts the interior slot side 93. Then a set screw 94 (or other securing mechanism) can be provided within a threaded bore 98 extending adjacent to the archwire retaining portion 100 in the slot 34a. Accordingly, if the top of the threads on the surface of the set screw 94 extend into the retaining portion 100 having the archwire 26, then when the set screw 94 is threaded through the bore 98, the threads of the set screw will bite into the archwire for fixing the archwire attachment 30a in place along the archwire 26. Additionally/alternatively, the archwire attachment 30a may be composed of a material that is bendable when the set screw 94 is threaded through the threaded bore 98, wherein upon tightening the set screw within the bore, the slot 34a crimps onto the archwire 26 thereby fixing the archwire attachment 30a in place along the archwire. Note that alternative techniques for fixing the archwire attachment 30a along an archwire 26 are also within the scope of the present disclosure. For example, an insert (not shown) may be provided in the slot 34a wherein this insert wraps around the three sides of the archwire 26 that face slot sides, and on the archwire' s side that faces the set screw 94, an extended portion of the insert covers the entry of the bore 98 into the slot 34a. Thus, when the set screw 94 contacts the extended portion, the set screw 94 forces this extended portion to tightly wrap around at least a part of the side of the archwire 26 that faces the patient's teeth and thereby fix the position of the archwire attachment 30a along the archwire.

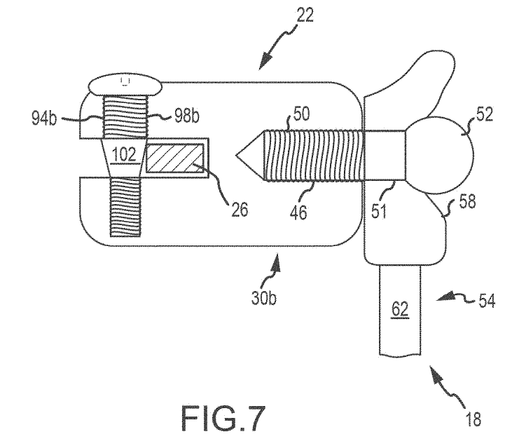

A further alternative embodiment of the archwire attachment (30b) is shown in FIG. 7 which is similar to the embodiment of FIG. 6 with the following exceptions: the threaded bore 98 (identified in FIG. 7 as 98b) has different threaded bore diameters on the sides of the slot 34a, and the set screw 94 (identified in FIG. 7 as 94b) has two corresponding threaded mating diameters for threading with respective portions of the threaded bore 98b. The set screw 94b further includes a tapered conical midportion 102 such that as the set screw 94b is threaded into the smaller bored portion, this tapered midportion enters the slot 34a adjacent to but, e.g., not contacting the archwire 26. However, as the set screw 94b is threaded further into the slot 34a, the diameter of the tapered midportion 102 becomes larger and commences to contact a larger and larger area of the archwire 26 thereby deforming the archwire into the inverse of the shape of the tapered conical midportion 102 for securing the archwire attachment 30b in place along the archwire.

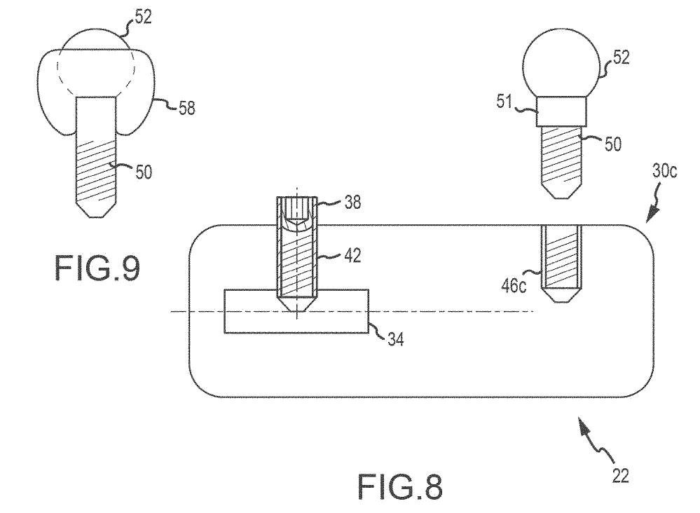

A further alternative embodiment of the archwire attachment (30c) is shown in FIG. 8, which is similar to the embodiment of FIG. 5 with the following exception: the threaded bore 46c for mating with, e.g., a threaded screw/shaft 50 (for pivotally securing an eyelet 58 thereto), is provided on the same side of the attachment 30c as the threaded bore 42 is located.

In operation, a clinician may perform the following steps in utilizing the correction system 10.
Step 1.1. Determine the type(s) of orthodontic abnormalities to treat with the correction system 10.
Step 1.2. If the abnormality is a Class II malocclusion, then one of the correction assemblies 14 may be fixed (between maxillary and mandibular archwires 26) on each of the left and right sides of the patient's dentition so that the corresponding induced orthodontic forces, applied to each of the left and right side of the patient's jaw, are substantially the same for urging the patient's lower jaw and/or dentition to develop/move uniformly forward.
Step 1.3. If the abnormality is a Class III malocclusion, then one of the correction assemblies 14 may be fixed (between maxillary and mandibular archwires 26) on each of the left and right sides of the patient's dentition so that orthodontic forces applied to each of the left and right side of the patient's jaw are substantially the same for inducing the mandibular dentition to move uniformly backward and the upper dentition to move uniformly forward.
Step 1.4. If the abnormality is an asymmetry, then a plurality of the correction assemblies 14 may be used wherein at least two such assemblies induce forces that purposefully differ in magnitudes, and/or their directions along their respective axes 28. In particular, for treating such an asymmetry, one or more correction assemblies 14 may be installed on each side of the patient's dentition, wherein the correction assemblies on one side of the patient's dentition are: (i) longer than those on the other side of the patient's dentition, and (ii) oriented at an angle more traverse to the axes of the patient's teeth.

For attaching a correction assembly 14 to a patient's dentition, a clinician may perform the following steps.
Step 2.1. Determine a position for attaching the correction assembly 14 to each of the maxillary archwire 26 and the mandibular archwire 26.
Step 2.2. Position an archwire attachment (30, 30a-30d) of the correction assembly 14 in its position on the maxillary archwire, and secure this archwire attachment with its corresponding screw, rod, or rod shaped wire as described herein.
Step 2.3. Position an archwire attachment (30, 30a-30d) of the correction assembly 14 in its position on the mandibular archwire, and secure this archwire attachment with its corresponding screw, rod, or rod shaped wire as described herein.
Step 2.4. Lengthen or shorten the alignment assembly 18 as needed to provide the desired orthodontic pressures on patient's dentition or jaw adjacent the positions where the archwire attachments of Steps 2.2 and 2.3. In particular, depending on the embodiment of the alignment assembly 18 used, provide shims 70 on the shaft 62 (FIG. 2), rotate the collar 74 (FIG. 3), rotate one of the spacer 86 or the threaded shaft 62 (FIG. 4), or tighten a set screw into a threaded hole in the sleeve 66 so that this set screw tightly contacts the shaft 62 within the sleeve.
Step 2.5. For the archwire attachment of Step 2.2, provide the shaft of the screw/shaft 50 within the eyelet 58 of the correction assembly 14, and then thread this screw/shaft into the threaded bore 46 or 46c of the archwire attachment wherein this eyelet is sandwiched between a side of the archwire attachment and the head 52 of the screw/shaft 50.
Step 2.6. For the archwire attachment of Step 2.3, provide the shaft of the screw/shaft 50 within the eyelet 58 of the correction assembly 14, and then thread this screw/shaft into the threaded bore 46 or 46c of the archwire attachment wherein this eyelet is sandwiched between a side of the archwire attachment and the head 52 of the screw/shaft 50.

Thus, by affixing one or more of the correction assemblies 14 to previously installed archwires 26, as described above, substantially guarantees movement of the patient's teeth and/or jaw alignment. Moreover, the forces induced by an alignment assembly 18 on the orthodontic brackets that secure one of the archwires 26 to the patient's teeth, are:
(i) only indirectly transmitted to such brackets (via the one archwire 26),
(ii) distributed over two or more brackets secured to the one archwire 26 wherein (an embodiment of) the archwire attachment (for the alignment assembly) is attached between these brackets, and
(iii) somewhat cushioned by the flexing of the archwire 26.

Accordingly, due to at least (i) through (iii) above, there is a reduction in unintentional detachment (e.g., debonding) of the orthodontic brackets, and there is a reduction in such brackets slipping or misaligning from their prescribed positions on the patient's teeth. Moreover, since the orthodontic forces induced by one or more installed alignment assemblies are directly applied to the archwires 26, to the upper and lower dentitions, the clinician can have greater control in the treatment of malocclusions and dental asymmetries since, e.g., these conditions, in general, effect the aggregate configuration of a patient's dentition, instead of, e.g., a localized misalignment of one or two teeth.

It is further noted that orthodontic correction system 10 can be used for orthodontic micro-adjustments by changing, e.g., the position of the archwire attachment(s) 30 (or 30a, 30b or 30c) on one or more of the archwires 26. In particular, based upon the fixation position of the archwire attachment(s) on an archwire(s) 26, the clinician can change the amount of the forces applied. Moreover, the orthodontic correction system 10 can control individual tooth movement in some circumstances, e.g., distallization of maxillary second molars. Further, in some installations of one or more of the alignment assemblies 18, the longer the length of such installed assemblies 18, the better the orthodontic control and leverage over the patient's dentition and teeth.

In still other embodiments, an orthodontic system is set forth where the piston assembly attaches to the maxillary archwire attachment via a screw upon which a corresponding one of the eyelet pivots and to which one of the mandibular piston assemblies attaches to a temporary anchorage device (TAD). In one embodiment, the TAD is affixed to bone and a mandibular hinge is thereafter affixed to the TAD. A ball hinge 50, comprised of a spherical head 52, shaft 51 and eyelet 58 is provided such that the eyelet 58 pivotally attaches to the alignment assembly 18. Various embodiments include an orthodontic system that can solely distalize the maxillary dentition (molars) and at the same time create orthopedic mandibular changes due to the employment of a ball hinge/joint pivot.

In certain embodiments, a ball hinge/joint is associated with a temporary anchorage device for pure orthopedic changes when attached to upper and lower jaws. When attached to the mandible and on the maxillary archwire, distallization forces on the maxillary molars is achievable. A temporary anchorage device in a preferred embodiment has a threaded adaptor to accept a ball hinge/pivot with a screw-on collar, e.g., a ball hinge threaded adapter with a spherical head/ball joint. Thus, the piston assembly 54 is attached to each jaw via a corresponding one of two eyelets 58 (as shown, for example, on FIG. 5) which attaches to each terminal end of the piston assembly. Each eyelet 58 receives a corresponding ball hinge 50 comprised of a spherical head 52, shaft 51 and eyelet 58 such that the eyelet 58 pivotally attaches the alignment assembly 18 to a corresponding one of the TAD attachments.

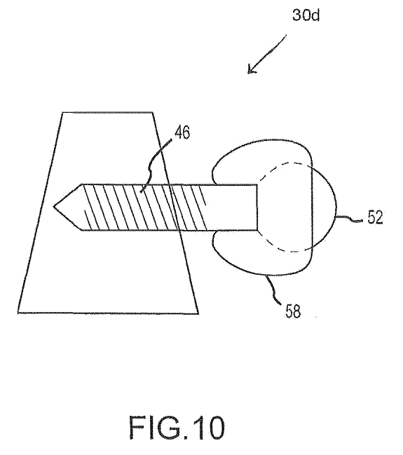

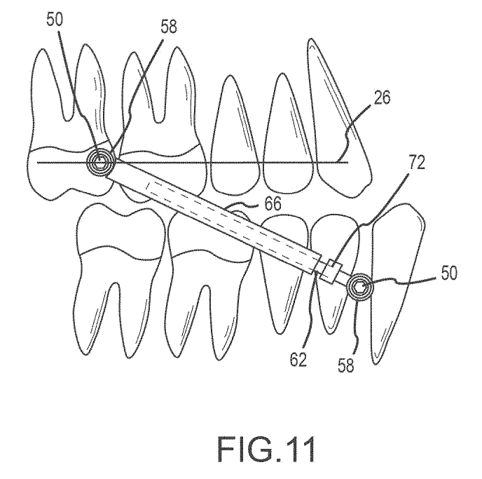

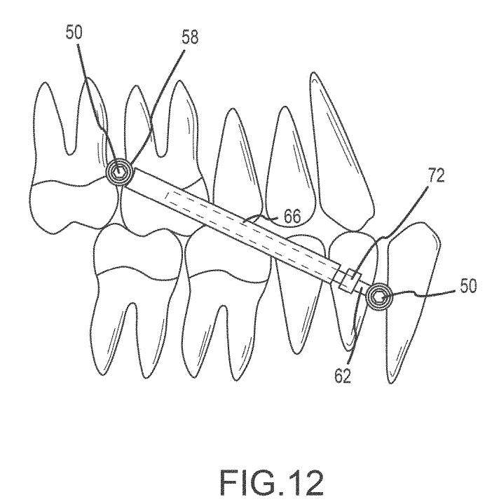

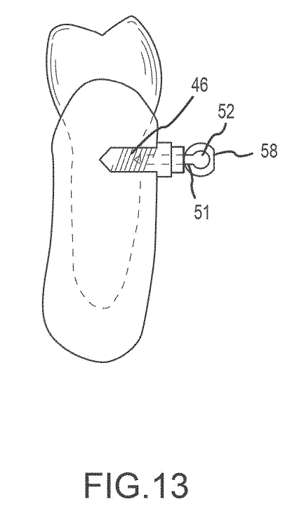

As shown in FIG. 10, in one embodiment of the invention, a temporary anchorage device (TAD) with a spherical head/ball joint attachment is provided. The anchorage device is inserted into the jaw bone with the threaded portion being of any suitable configuration, but in particular a conical one wherein the threaded portion 46 of the curved ball portion 52 screw forms approximately 50% of the device. A shoulder flange is provided above the threaded portion, followed by a stem and then a curved ball portion 52 to facilitate rotational movement around such structure.

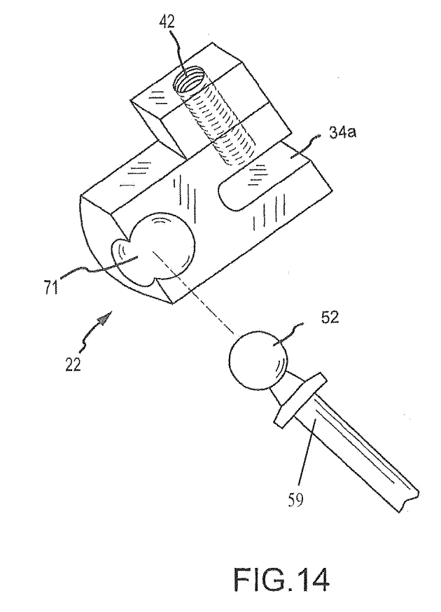

With respect to FIG. 14, one embodiment is shown where an archwire slot 34a is illustrated adjacent to a threaded bore 42 and wherein the structure includes a keyhole slot 71 to accept a male piston assembly's curved ball portion 52. The keyhole slot 71 is of a pressure fit design in a preferred embodiment, such that the curved ball portion 52 snaps into place creating a ball and socket joint. The curved ball portion 52 on the male piston shaft assembly is further illustrated in FIG. 14. A “T” or bayonet shaped attachment 59 is affixed to the curved ball portion 52.

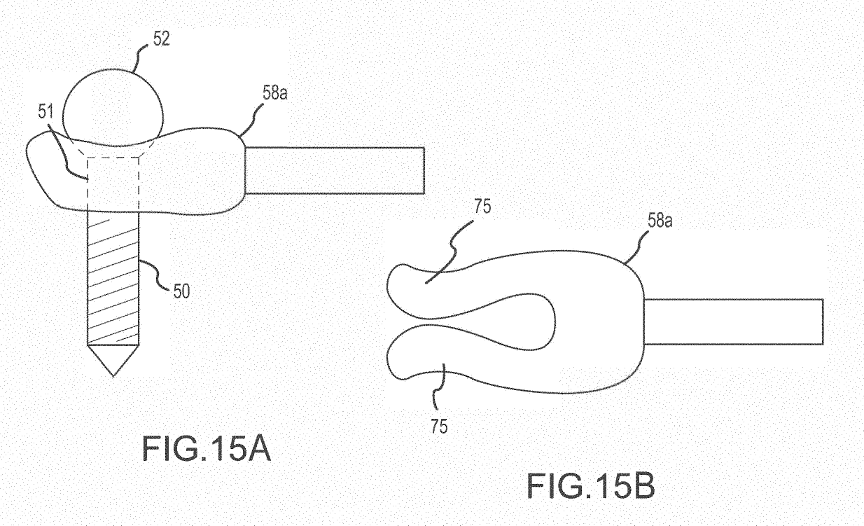

With respect to FIG. 15, a unique clip style eyelet attachment 58a increases the ease of attachment of the piston assembly 18 to the attachment screw 52. The cliphead arms 75 open, e.g., spread apart, to slip around shaft 51, and then close around the shaft to securely attach the assembly to the screw/shaft 50.

A particular advantage of embodiments of the present invention is the unrestricted motion and/or excursion permitted by the ball joint. This advantage is not provided by previous solutions for the correction of malocclusion and/or asymmetry. For example, U.S. Patent Application Publication 2006/0234180 to Huge et al. (“Huge”), the entirety of which is incorporated herein by reference, teaches a pivot to which a rod portion of a telescoping Herbst appliance is attached through an eyelet. The pivot of Huge is a modified single-axis pivot incorporating a saddle, i.e. a concave surface, which by design limits the lateral excursion of the rod of the Herbst appliance to approximately 21°, as shown in FIG. 9 of Huge. The range of angular motion permitted by the design of Huge is severely limited compared to the present invention, in which the ball joint utilizes a spherical head 52 having a continuously convex surface as opposed to the concave or “cut-out” shape taught by Huge. Thus, the ball joint of the present invention permits unrestricted lateral excursion and/or motion of the Herbst-type appliance, and the greater range of natural movement permitted by the present invention reduces breakage associated with previously known conventional Herbst appliances.

FIG. 14 illustrates further advantages of embodiments of the present invention over the prior art. For instance, the pivot taught by FIGS. 5 and 10 of Huge incorporates a recessed socket that may be accessed by an Allen wrench to tighten or loosen the apparatus. This design requires a clinician to use a driver in the patient's mouth, which may significantly diminish the comfort of, or cause discomfort to, the patient. In the present invention, the spherical head 52 has a friction fit with socket 71, increasing patient comfort. As illustrated in FIG. 14, the ball joint of the present invention is a true ball-and-socket joint that is not joined by a threaded connection, unlike the pivot of Huge, which incorporates threads in at least one end.

As illustrated by the following Clinical Examples, embodiments of the present invention have successfully treated extremely difficult orthodontic cases in which appliances of the prior art failed or would have failed, and/or orthognathic (jaw) surgery or permanent tooth extractions would otherwise have been necessary.

### Clinical Example 1

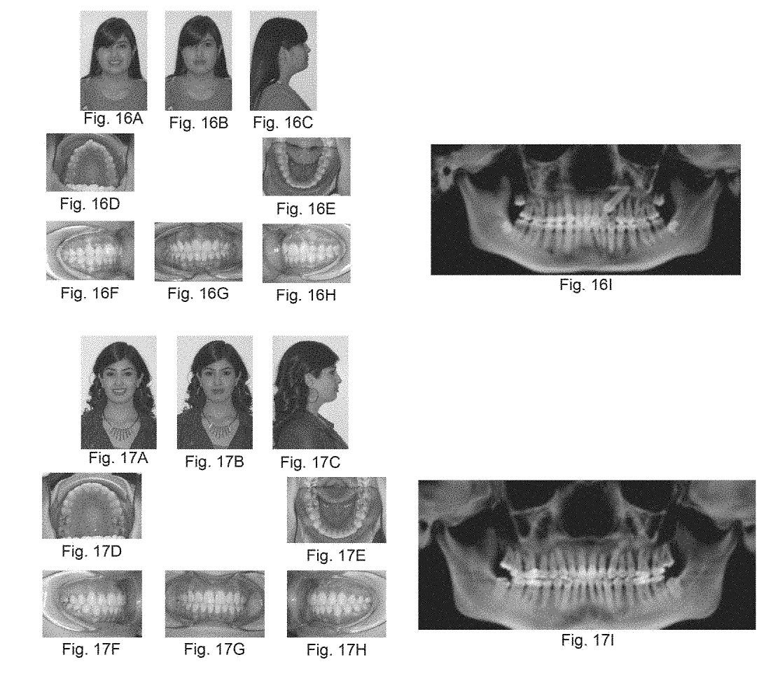

A 14-year-old female patient presented with a severe Class II malocclusion, in which the upper dentition is displaced forward relative to the lower dentition, due in part to an impacted left maxillary canine, as illustrated in FIGS. 16A through 16I. At the time of invention, orthodontists skilled in the art would have considered this case to be extremely difficult to treat without permanent tooth extraction and/or jaw surgery.

This patient was initially treated with the Herbst appliance taught by U.S. Pat. No. 5,879,157 to Scheu (“Scheu”), which was the state of the art prior to the present application. The patient showed no clinical improvement when treated with the appliance of Scheu.

Subsequently, this patient was treated with an embodiment of the present invention. The appliance produced better direction of forces than the Scheu appliance, and, unlike the Scheu appliance, allowed multiple axes of free rotation due to the use of ball hinges. The patient's malocclusion was completely resolved after treatment with an embodiment of the present invention, as illustrated in FIGS. 17A through 17I.

Treating this patient with the Herbst appliance taught by Scheu would not have resulted in the improved clinical outcomes provided by the present invention, even if the appliance of Scheu had been modified by incorporating elements of other prior art appliances, such as that taught by Huge. Thus, this Clinical Example represents surprising and unexpected results relative to the prior art as a whole.

### Clinical Example 2

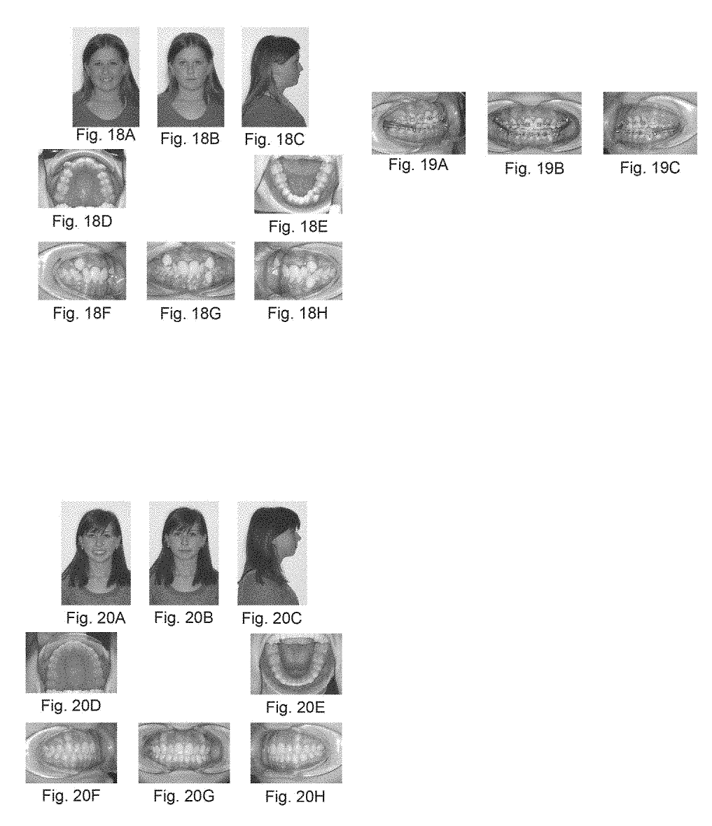

An 11-year-old female patient presented with severe crowding and severe midline asymmetry, with the midline of the lower arch displaced to the left, as illustrated in FIGS. 18A through 18H. At the time of invention, orthodontists skilled in the art typically would have treated this case by extracting permanent teeth to resolve the crowding and correct the position of the midline of the lower arch.

The patient was treated with an embodiment of the present application, as illustrated in FIGS. 19A through 19C. The appliance successfully resolved both the crowding and the midline asymmetry, as illustrated in FIGS. 20A through 20H. This clinical outcome is significant because extraction of permanent teeth, which would have greatly increased both the cost of treatment and the patient's discomfort, was not necessary.

Treating this patient with the Herbst appliance taught by Scheu would not have resulted in the significantly improved clinical outcomes achieved by the present invention, even if the appliance of Scheu had been modified by incorporating elements of other prior art appliances, such as that taught by Huge. Thus, this Clinical Example represents surprising and unexpected results relative to the prior art as a whole.

### Clinical Example 3

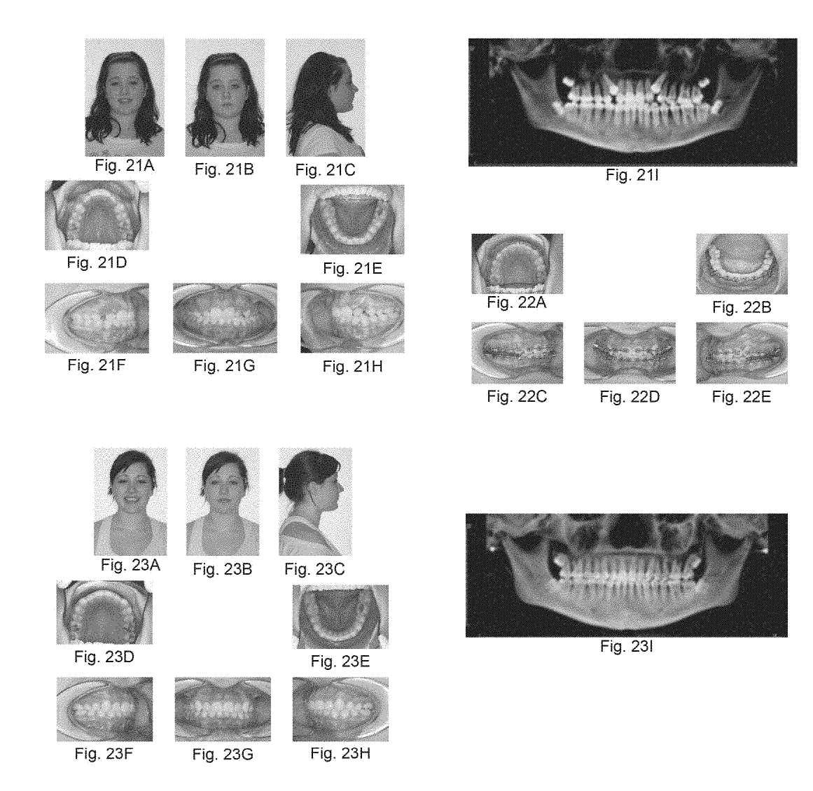

A 12-year-old female patient presented with severe crowding, a left posterior crossbite, multiple impacted canines, and a severe Class II malocclusion, as illustrated in FIGS. 21A through 21I. At the time of invention, orthodontists skilled in the art traditionally would have treated this extremely difficult case by extracting either the upper canines or the upper first premolars.

This patient could not have been successfully treated with the Herbst appliance taught by Scheu, which was the state of the art prior to the present application, because the appliance of Scheu is not designed to move teeth distally (backward) or mesially (forward).

This patient was treated with an embodiment of the present application, as illustrated in FIGS. 22A through 22E. The appliance moved the upper posterior teeth distally (backward) and the lower teeth mesially (forward), which corrected the crossbite and the Class II malocclusion and made room for the impacted canines to descend, as illustrated in FIGS. 23A through 23I. Neither surgery nor tooth extraction was necessary.

Treating this patient with the Herbst appliance taught by Scheu would not have resulted in the improved clinical outcomes provided by the present invention, even if the appliance of Scheu had been modified by incorporating elements of other prior art appliances, such as that taught by Huge. Thus, this Clinical Example represents surprising and unexpected results relative to the prior art as a whole.

As one of ordinary skill in the art will understand and be guided by through an understanding of the present disclosure, a ball and socket assembly is provided in various embodiments of the present invention to permit freer degrees of movement of anchored ends of the orthodontic system as set forth herein.

The foregoing disclosure has been presented for purposes of illustration and description. Further, the above disclosure is not intended to limit the claimed invention(s) to the form disclosed herein. Consequently, variation and modification commiserate with the above teachings, within the skill and knowledge of the relevant art, are within the scope of the present disclosure. The embodiment described hereinabove is further intended to explain the best mode presently known of practicing the claimed invention(s) and to enable others skilled in the art to utilize the claimed invention as such, or in other embodiments, and with the various modifications required by their particular application or uses of the claimed invention(s).

1. An orthodontic system for correcting a malocclusion or an asymmetry, comprising:
a variable length alignment assembly having a piston assembly including a female piston sleeve and a male piston shaft that mate together in a manner that allows a length of the alignment assembly to be adjusted by a clinician, wherein the piston assembly includes threaded mating portions for varying a length of the alignment assembly;
a ball hinge at each end of the alignment assembly, wherein the ball hinge includes an archwire attachment having a threaded bore and a threaded pivot shaft for allowing the said alignment assembly to pivot and freely rotate, said ball hinge comprising a spherical head that pivotally attaches, allowing unrestricted excursion along multiple axes, to said alignment assembly, wherein the threaded bore of the archwire attachment surrounds and mates with the threaded pivot shaft;
a first eyelet attached to the female piston sleeve at a first end of the piston assembly and a second eyelet attached to the male piston shaft at a second end of the piston assembly; and
wherein the archwire attachment includes an archwire slot for providing an archwire therein and a securing mechanism comprising a threaded screw for fixedly securing the archwire attachment at a desired position along a length of the archwire.

2. The orthodontic system of claim 1, wherein at least one of the hinges is made of a metal alloy with the archwire slot being one of: 0.022×0.025 inches or 0.018×0.025 inches.

3. The orthodontic system of claim 1, wherein the archwire slot has a set screw coming in at a 90-degree angle to the slot for affixation to the archwire in the slot.

4. The orthodontic system of claim 1, wherein the piston assembly attaches to the archwire attachment via a screw upon which a corresponding one of the eyelet pivots.

5. The orthodontic system of claim 1, further including one or more shims to alter a length of the piston assembly.

6. The orthodontic system of claim 1, further including a collar having an interior for receiving at least a portion of the sleeve, the collar having a fixation device for fixing a position of the collar along a length of the shaft to thereby adjust the length of the alignment assembly.

7. The orthodontic system of claim 1, wherein the securing mechanism includes a threaded shaft or screw for mating with a threaded bore that opens into the archwire slot.

8. The orthodontic system of claim 1, wherein the orthodontic system moves the maxillary teeth distally and the mandibular teeth mesially into a Class I relationship.

9. The orthodontic system of claim 1, wherein the orthodontic system moves the maxillary teeth mesially and the mandibular teeth distally for obtaining a Class I relationship.

10. The orthodontic system of claim 1, wherein the orthodontic system moves the maxillary teeth mesially.

11. An orthodontic system for correcting a malocclusion or an asymmetry, comprising:
a variable length alignment assembly having a piston assembly including a female piston sleeve and a male piston shaft that mate together in a manner that allows a length of the alignment assembly to be adjusted by a clinician, wherein the piston assembly includes threaded mating portions for varying a length of the alignment assembly;
a ball hinge at each of two ends of the alignment assembly, wherein each of the ball hinges includes an archwire attachment having a threaded bore and a threaded pivot shaft for allowing the alignment assembly to pivot around the archwire attachment, said ball hinge comprising a spherical head that pivotally attaches, allowing unrestricted excursion along multiple axes, to said alignment assembly, wherein the threaded bore of the archwire attachment surrounds and mates with the threaded pivot shaft; and
wherein the archwire attachment includes an archwire slot for providing an archwire therein, and a securing mechanism comprising a threaded screw for fixedly securing the archwire attachment at a desired position along a length of the archwire.

12. The orthodontic system as set forth in claim 11, wherein said orthodontic system solely distalizes the maxillary dentition and at the same time creates mesially directed orthopedic mandibular changes due to pivotal movement about said ball hinge.

13. The orthodontic system as set forth in claim 11, said system further comprising a temporary anchorage device having a threaded portion adapted for insertion into a jaw bone, with said threaded portion forming approximately 50% of the temporary anchorage device.

14. The orthodontic system as set forth in claim 11, further comprising an eyelet with a key hole slot attached to the male piston shaft and/or the female piston sleeve assembly that accepts a spherical head.

15. The orthodontic system as set forth in claim 16, wherein the key hole slot of the male and/or female piston assembly has a pressure fit design such that the male piston head snaps onto the spherical ball/head portion of the archwire attachment to create a ball and socket joint.

16. The orthodontic system as set forth in claim 11, wherein said system further comprises a clip style attachment having clip head arms adapted to spread apart and thereby slip around and close around a shaft to securely attach said alignment assembly.

17. An orthodontic system for correcting a malocclusion or an asymmetry, comprising:
a variable length alignment assembly having a piston assembly including a sleeve and a shaft that mate together in a manner that allows a length of the alignment assembly to be adjusted by a clinician, wherein the piston assembly includes threaded mating portions for varying a length of the alignment assembly;
a ball hinge at each of two ends of the alignment assembly, wherein each of the ball hinges includes an archwire attachment having a threaded bore and a threaded pivot shaft for allowing the archwire attachment to pivot, said ball hinge comprising a spherical head that pivotally attaches, allowing unrestricted excursion along multiple axes, to said alignment assembly, wherein the threaded bore of the archwire attachment surrounds and mates with the threaded pivot shaft;
wherein the archwire attachment includes an archwire slot for providing an archwire therein, and a securing mechanism comprising a threaded screw for fixedly securing the archwire attachment at a desired position along a length of the archwire;
wherein said alignment assembly comprises a clip style attachment having clip head arms adapted to spread apart and thereby slip around and close around a shaft to securely attach said alignment assembly;
wherein said system further comprises a “T” or bayonet attachment wherein the male piston shaft and female piston sleeve assembly have an eyelet with a keyhole slot that accepts a “T” or bayonet shaped attachment affixed to a spherical head/ball portion on a TAD that facilities rotational movement about the TAD.

18. An orthodontic system for correcting a malocclusion or an asymmetry, comprising:
a variable length alignment assembly having a piston assembly including a sleeve and a shaft that mate together in a manner that allows a length of the alignment assembly to be adjusted by a clinician, wherein the piston assembly includes threaded mating portions for varying a length of the alignment assembly;
a ball hinge at each end of the alignment assembly, wherein said ball hinge includes an archwire attachment having a threaded bore and a threaded pivot shaft for allowing the alignment assembly to pivot, said ball hinge comprising a spherical head that pivotally attaches, allowing unrestricted excursion along multiple axes, to said alignment assembly, wherein the threaded bore of the archwire attachment surrounds and mates with the threaded pivot shaft;
a first eyelet attached to an end of the female piston sleeve and a second eyelet attached to an opposite end of the male piston shaft;
wherein the archwire attachment includes an archwire slot for providing an archwire therein and a securing mechanism comprising a threaded screw for fixedly securing the archwire attachment at a desired position along a length of the archwire; and
wherein said system further comprises a “T” or bayonet attachment wherein the male piston shaft and female piston sleeve assembly have an eyelet with a keyhole slot that accepts a “T” or bayonet shaped attachment affixed to a spherical head/ball portion on an archwire attachment that facilitates rotational movement about the archwire attachment.

19. An orthodontic system for correcting a malocclusion or an asymmetry, comprising:
a variable length alignment assembly having a piston assembly including a female piston sleeve and a male piston shaft that mate together in a manner that allows a length of the alignment assembly to be adjusted by a clinician, wherein the piston assembly includes threaded mating portions;
a collar having an interior for receiving at least a portion of the female piston sleeve, and a fixation device for fixing a position of the collar along a length of the shaft to thereby adjust the length of the alignment assembly;
a ball hinge at each of two ends of the alignment assembly, wherein the ball hinge includes an archwire attachment having a threaded bore and a threaded pivot shaft for allowing the said alignment assembly to pivot and freely rotate, said ball hinge comprising a spherical head that pivotally attaches, allowing unrestricted excursion along multiple axes, to said alignment assembly, wherein the threaded bore of the archwire attachment surrounds and mates with the threaded pivot shaft; and
a first eyelet attached to the female piston sleeve at a first end of the piston assembly and a second eyelet attached to the male piston shaft at a second end of the piston assembly, each eyelet having a keyhole slot that accepts a “T” or bayonet shaped attachment affixed to the spherical head of the ball hinge to facilitate rotational movement about the archwire attachment, wherein at least one keyhole slot has a pressure fit design such that the corresponding one of the female piston sleeve and the male piston shaft snaps onto the spherical head of the ball hinge to create a ball and socket joint,
wherein the archwire attachment includes an archwire slot for providing an archwire therein, and a securing mechanism comprising a threaded screw for fixedly securing the archwire attachment at a desired position along a length of the archwire, the threaded screw mating with a threaded bore that opens into the archwire slot,
wherein the orthodontic system moves the maxillary teeth mesially and the mandibular teeth distally to obtain a Class I relationship.

20. An orthodontic system for correcting a malocclusion or an asymmetry, comprising:
a variable length alignment assembly having a piston assembly including a female piston sleeve and a male piston shaft that mate together in a manner that allows a length of the alignment assembly to be adjusted by a clinician, wherein the piston assembly includes threaded mating portions;
a collar having an interior for receiving at least a portion of the female piston sleeve, and a fixation device for fixing a position of the collar along a length of the shaft to thereby adjust the length of the alignment assembly;
a ball hinge at each of two ends of the alignment assembly, wherein the ball hinge includes an archwire attachment having a smooth bore and a smooth pivot shaft for allowing the said alignment assembly to pivot and freely rotate, said ball hinge comprising a spherical head that pivotally attaches, allowing unrestricted excursion along multiple axes, to said alignment assembly, wherein the smooth bore of the archwire attachment surrounds and mates with the smooth pivot shaft; and
a first eyelet attached to the female piston sleeve at a first end of the piston assembly and a second eyelet attached to the male piston shaft at a second end of the piston assembly, each eyelet having a keyhole slot that accepts a “T” or bayonet shaped attachment affixed to the spherical head of the ball hinge to facilitate rotational movement about the archwire attachment, wherein at least one keyhole slot has a pressure fit design such that the corresponding one of the female piston sleeve and the male piston shaft snaps onto the spherical head of the ball hinge to create a ball and socket joint,
wherein the archwire attachment includes an archwire slot for providing an archwire therein, and a securing mechanism comprising a threaded screw for fixedly securing the archwire attachment at a desired position along a length of the archwire, the threaded screw mating with a threaded bore that opens into the archwire slot,
wherein the orthodontic system moves the maxillary teeth mesially and the mandibular teeth distally to obtain a Class I relationship.
